(19) United States
(12) Patent Application Publication
(10) Pub. No.: US 2002/0108455 A1
(43) Pub. Date: Aug. 15, 2002

(54) Suction device

(76) Inventors: Osmo Suovaniemi, Helsinki (FI); Pertti Ekholm, Helsinki (FI)

Correspondence Address: BIRCH STEWART KOLASCH & BIRCH, PO BOX 747, FALLS CHURCH, VA, 22040-0747, US

(21) Appl. No.: 10/058,038

(22) Filed: Jan. 29, 2002

(30) Foreign Application Priority Data
Feb. 9, 2001 (FI) 20010247

(51) Int. Cl. G01N 1/14

(52) U.S. Cl. 73/864.13; 73/864.18

(57) ABSTRACT

The object of the invention is a method for adjusting the dispensing volume in a pipette having a spring for returning a plunger to its initial position. The invention is characterized in that when the pipetting volume is adjusted, the spring moves in accordance with the adjustment together with the adjustment members, preserving its length and/or pretension, whereby the tension of the spring does not change when the pipetting volume is adjusted. The object of the invention is also a pipette for implementing the method.

The object of this invention is a method for adjusting the dispensing volume in a suction device for dispensing liquids, such as a pipette, comprising a body with associated end part to which can be removably attached a tip enclosing a sample space for receiving a liquid sample, members for moving a reciprocatingly movable plunger in a cylinder space for receiving a sample in the tip, members such as a spring for returning the plunger to its initial position, and members for adjusting the dispensing volume.

The object of this invention is also a device for implementing the method.

Previously known air displacement pipettes comprise a body, formed by a handle, with an associated end part to which a tip, e.g., a disposable tip, is attached. The end part encloses a cylinder space containing a reciprocatingly movable plunger for changing the volume in the cylinder space in order to receive a sample in the tip and/or removing it therefrom. The plunger is attached to a rod extending outside the body and having a push button at its end. For returning the plunger to its initial position, the pipette has means, such as a spring, which can be placed in a cylinder space between the plunger and a shoulder provided inside the cylinder space, or the spring can be fitted around the rod, between a shoulder on the rod and the body of the pipette. The spring is usually pretensioned, causing the plunger to be pulled into the cylinder when being in its initial position.

Previously known positive displacement pipettes contain a removably attached tip or a tip-container having a reciprocatingly movable plunger. The plunger is attached to a rod, which extends outside the body having a press-button at its end. As in above referred air displacement pipettes, also in positive displacement pipettes a spring is used for returning the plunger to its initial position.

When pipetting, the user presses the plunger from its initial position towards the end part to its starting position for taking a sample. When the plunger is allowed to return from said starting position, away from the tip part, the desired volume of liquid to be dispensed is drawn inside the tip, which is submerged in said liquid. Dispensing the sample drawn into the tip, for example to another container, the user presses the plunger towards the end part of the pipette. To enable complete removal of the sample from the tip, pipettes often have a possibility to press the plunger past the starting position towards the end part. This procedure is called blow-out. To enable the user to tell the difference between the starting position and the blowout position, pipettes are often equipped with an additional spring, which starts to resist the pressing of the plunger towards the end part when the starting position is reached. When the user presses the plunger towards the end part, he/she notices the increase in resisting force when passing the starting position.

For adjusting the pipetting volume, a pipette has adjustment means, which are used to limit the plunger stroke according to the desired volume. The adjusting means are composed, for example, of a threaded sleeve connected to the press-button, which sleeve may be turned in relation to the body by turning the press-button, whereby, for example, when the volume is to be decreased, the rod attached to the sleeve and the plunger attached to the rod move towards the end part. One end of the return spring is attached to the plunger, to an extension thereof or to the rod, and the other end of the spring is attached to the body or to a fixed part connected to the body. As one end of the spring is fixed, or connected to the body or to an immovable part of the body, and the other end of the spring is fixed or connected to the parts movable while adjusting the volume, the length of the spring, and consequently the tension of the spring, are different in the various setting positions.

When the pipetting volume is adjusted smaller, the plunger return spring is compressed, whereby the springback factor resisting the motion of the plunger is the smallest when the volume is the largest and vice versa. Accurate pipetting is, particularly at lower volumes, very difficult because a large force is required to perform a short pipetting movement. There is also a stage in pipetting when the plunger is held stationary, whereby the spring is in static tension, and in conventional pipettes the springback factor is then at its greatest, and this causes strain for the user.

When the resisting force of the return spring is high at small volumes, also the above mentioned additional spring relating to blow-out, the secondary spring, needs to be selected according to a large springback factor, so that the user can notice reaching the starting position.

In pipettes used within a wide volume range, a large adjustment range is needed. Then the plunger stroke range is also large, whereby respectively a long spring must be used. When such a long spring is compressed, it does not stay straight, but the coils of the spring are displaced from the spring's longitudinal axis, whereby the coils come, at least partially, in contact with the surrounding surfaces, which causes friction and adherence, both when adjusting the volume and when pressing the press-button.

In the method according to the invention, these disadvantages can be eliminated. The method according to this invention is characterized in that while the pipetting volume is adjusted, the means for returning the plunger to its initial position, such as a spring, move in parallel with the pipette longitudinal axis together with the adjusting means while preserving their length and/or pretension or preset condition according to the setting. This is preferably achieved, for example, by adapting the returning spring or corresponding members between two parts, which do not move in relation to one another while the pipetting volume is adjusted. Because, in the method according to the invention, both ends of the spring move according to the setting simultaneously and in the same direction, the tension of the spring does not substantially change while adjusting the pipetting volume either. In the method according to the invention, the points of attachment and/or support of the ends of the means for returning the plunger to its initial position, preferably e.g. of the return spring, are thus selected, that the distance between them remains essentially unchanged during volume adjustment.

It is obvious to a person skilled in the art that the method according to the invention can be adapted in both air displacement pipettes and positive displacement pipettes.

In the method according to the invention, the springback factor of the secondary spring can be selected smaller than in conventional pipettes and the user can more easily tell the difference when moving to the blow-out range while pressing the plunger towards the end part.

In order to cause as little strain on the user as possible, the pretension of the return spring must be chosen as low as possible. Due to the structure of the pipette and the components used, and the possible wear of these components, the restoring force for returning the plunger to its initial position can depend on the positions of the plunger and adjusting means.

In one embodiment of the invention, the prestress force is set to a minimum, in another words, such that the prestress force is selected corresponding to the highest force required for returning the plunger to its initial position at all plunger or volume settings. In this case, the force exerted on the pipette structure by the spring is at a minimum and it does not depend on the volume set in the pipette. This is significant, for example, when autoclaving a pipette for sterilization. In autoclaving, the temperatures used are close to the highest allowed operating temperatures of the plastic materials generally used. If the spring is stressed at high force during autoclaving, transformations in the pipette structure may appear, whereby the accuracy of the pipette decreases.

The method according to the invention can be used regardless of whether the means used for returning the plunger to its initial position is one or several pressure springs, extension springs, a combination of these or other appropriate spring means. When a pressure spring is used, it is placed, in an advantageous embodiment of the invention, between the press-button used for adjusting the pipetting volume and the adjusting screw, or means connected to the adjusting screw and moving along with it.

The apparatus according to the invention is characterized in that the ends of the means used for returning the plunger to its initial position, preferably e.g. a return spring, are attached to or supported by movable parts, the distance between which is substantially the same in all positions occupied by these movable parts, said positions corresponding to set volumes and said parts being moved when volume adjustment is made.

Moving and movable parts used in such volume adjustments are for example the adjustment knob, members connected thereto such as an adjusting screw, a plunger, a plunger extension and/or a plunger rod or other corresponding members, as well as means connected to these and/or means included in these, such as lugs, flanges, stops, dents, cavities.

The method according to the invention can also be used in multi-channel pipettes or other multi-channel suction devices.

In the following, the invention is described in more detail with reference to the drawings, in which

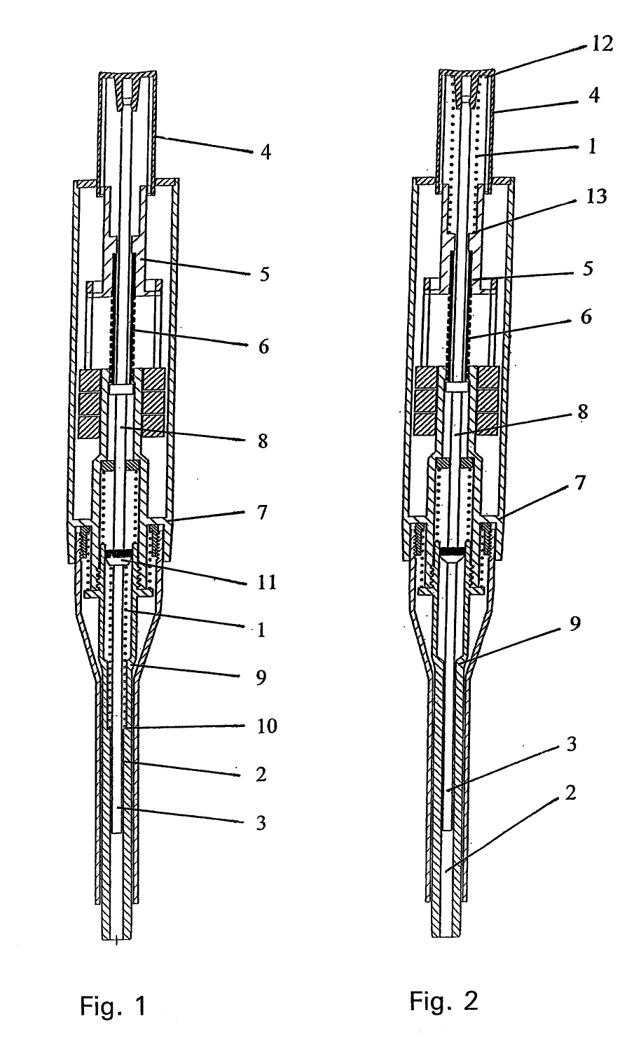

FIG. 1 discloses a lengthwise cross-section of a pipette previously known in the art and

FIG. 2 discloses a lengthwise cross-section of a pipette according to the invention.

In FIGS. 1 and 2, like reference numbers are being used for like parts.

In FIG. 1 the body of the pipette is referred with reference number 7, the end part of the pipette with reference number 9, whose end is formed for removably attaching a tip. The end part of the pipette 9 encloses a cylinder 2 where there is a reciprocatingly movable plunger 3. The plunger 3 is attached to a plunger rod 8, and to a part of the plunger rod 8 extending outside the body 7 there is a knob 4 attached. An adapter 5 is attached to the knob 4 and to the adapter 5 an adjusting screw 6 is attached. When the knob 4 is turned, adapter 5 turns along with the knob and adjusting screw 6 attached to it turns in relation to body 7, at the same time moving rod 8 and plunger 3 attached thereto. The knob 4 has longitudinal grooves receiving the lugs of adapter 5. When knob 4 is pressed to move plunger 3 towards the end part of the pipette, knob 4 moves in the longitudinal direction of the pipette, simultaneously displacing plunger rod 8 and plunger 3 attached to it in the same direction without moving adapter 5. When knob 4 is turned, adapter 5 turns along with knob 4 due to the grooves of knob 4 and the associated lugs of adapter 5.

The return spring 1 of the plunger is mounted in the air space of the cylinder between a shoulder 10 in the part of the cylinder 2 facing towards the end part of the pipette, and a fixed stop 11 on plunger 3. When knob 4 is turned, plunger 3 moves, depending on the direction of rotation, either towards the end part or away from it. The length, and simultaneously the tension, of return spring 1 then changes according to the volume setting.

FIG. 2 shows a pipette according to the invention as a longitudinal cross-section. In this example the return spring 1 is a pressure spring, which is adapted inside knob 4 between a stop 12 in knob 4 and a shoulder 13 in the adapter 5. When knob 4 is turned, adapter 5 turns also, whereby the length of spring 1 and its tension do not change. When knob 4 is turned for volume adjustment, the distance between the mounting faces and/or the supporting surfaces of spring 1 in knob 4 and respectively in adapter 5 remains stationary. When knob 4 is pressed in the longitudinal direction of the pipette, the longitudinal grooves in knob 4 and the lugs of adapter 5 allow the knob 4 to move in the longitudinal direction of the pipette in regard to adapter 5. The force caused by spring 1 resisting the pressing of the knob 4 is thus independent from the setting of the volume adjustment.

In another embodiment of the invention, volume adjustment is made by directly turning adapter 5, or through appropriate transmission members without using knob 4 to adjust the volume. Thus, knob 4 can be a member, which is not part of the volume adjustment mechanism, whereby it is preferably used only to accomplish longitudinal movement of plunger 3. In yet another embodiment, knob 4 and adapter 5 co-act in such a manner, that when knob 4 is pressed, knob 4 and adapter 5 move substantially only in the longitudinal direction of the pipette and when knob 4 is turned, knob 4 and adapter 5 substantially turn together.

In one preferable embodiment of the device according to the invention, an extension spring is used as a return spring, which in one favorable embodiment of the invention is fitted, for example, around plunger rod 8 and is attached at one end to adapter 5 and at the other end to plunger rod 8, for example, to an associated collar, lug or a taper in the rod. Also in this embodiment, the distance between the points of attachment at the ends of the spring 1 remains unchanged when the volume is adjusted, and does not depend on the set volume. When an extension spring is used as return spring 1, it demands less space in its initial position when tensioned straight.

The device according to the invention can also be a multichannel pipette or other multichannel suction device for dispensing liquids.

1. A method for adjusting dispensing volume in a suction device, such as a pipette, for dispensing liquids, comprising an end part (9) attached to a body (7), a tip for liquid samples removably attachable to the end part, means for moving a reciprocatingly movable plunger in a cylinder space for receiving a sample in the tip, means (1), such as a spring, for returning the plunger to its initial position and means for setting the dispensing volume, characterized in that when the pipetting volume is set, the means for returning the plunger to its initial position, such as a return spring (1), moves substantially maintaining its length and/or pretension, according to the setting, in the longitudinal direction of the pipette.

2. The method according to claim 1, characterized in that the return spring (1) is pretensioned so that the pretension force equals the highest force required for returning the plunger (3) to its initial position in every plunger (3) and volume adjustment position.

3. The method according to claim 1, characterized in that when the pipetting volume is adjusted, the distance between the points of attachment or support of the ends of the means for returning the plunger to its initial position, such as the ends of the return spring (1), remains essentially unchanged.

4. The method according to claim 1, characterized in that the suction device is a multi-channel pipette.

5. A suction device for dispensing liquids, such as a pipette, comprising a body (7) and an associated end part (9) to which a tip for receiving liquid samples can be removably attached, means for moving a reciprocatingly movable plunger in a cylinder space for receiving a sample in the tip, means (1), such as a spring, for returning the plunger to its initial position, and means for setting the dispensing volume, characterized in that the ends of the means for returning the plunger (3) to its initial position, such as the ends of the return spring (1), are attached to or supported by parts whose relative distance is substantially the same in all positions of the moving parts corresponding to dispensing volumes when the volume is adjusted.

6. The suction device according to claim 5, characterized in that the means (1) for returning the plunger to its initial position constitutes at least one pressure spring.

7. The suction device according to claim 5, characterized in that the means (1) for returning the plunger to its initial position constitutes at least one extension spring.

8. The suction device according to claim 5, characterized in that the means for returning the plunger to its initial position, such as a return spring (1) is adapted between a knob (4) for adjusting the volume and a volume adjusting screw (6) or means attached or associated to it.

9. The suction device according to claim 6, characterized in that one end of the means for returning the plunger to its initial position, such as a return spring (1), is supported by or attached at one end by appropriate members, to members connected to a volume adjustment screw (6) and at the other end to the plunger (3), an extension of the plunger (3), the plunger rod (8), or to members being part of or attached to these.

10. The suction device according to one of the claims 5-9, characterized in that the suction device is a multi-channel pipette.
